(19) United States
(12) Patent Application Publication
(10) Pub. No.: US 2017/0053229 A1
(43) Pub. Date: Feb. 23, 2017

(54) DISTRIBUTION SYSTEM AND METHOD

(71) Applicants: Gianluca Folino, Bolton (CA); Gianfranco Dadone, Bolton (CA)

(72) Inventors: Gianluca Folino, Bolton (CA); Gianfranco Dadone, Bolton (CA)

(21) Appl. No.: 14/832,352

(22) Filed: Aug. 21, 2015

(51) Int. Cl. G06Q 10/08; H04B 5/00

(52) U.S. Cl. CPC G06Q 10/087; H04B 5/0062

(57) ABSTRACT

A distribution system can include components, near field communication tags, a depository, and a computing device. A first tag can be engaged with a first component. A second tag can be engaged with a second component. Each tag can have a memory storing an identity record correlated to the respective component and a logistic record being the first of the two alternative values. The first component bearing the first near field communication tag and the second component bearing the second near field communication tag can be positioned in the depository. The computing device can have one or more processors and be configured to receive a first input including the first identity record and to change the first logistic record stored in the memory of one of the near field communication tags to a second of the two alternative values.

### BACKGROUND

1. Field

The present disclosure relates to near field communication (NFC) and, more particularly, to an NFC-based distribution system for controlling a flow of components out of a depository.

2. Description of Related Prior Art

U.S. Pub. No. 20120303483 discloses a NEAR FIELD COMMUNICATION (NFC)-BASED PAYMENT SYSTEM AND METHOD. The near field communication (NFC)-based payment method for supporting a payment between seller and purchaser terminals having an NFC module mounted therein includes: generating and storing a seller code based on seller identification information and sales product information received from the seller terminal, and providing the generated seller code to the NFC module of the seller terminal; generating a purchaser code based on purchaser identification information, purchase product information, and purchase payment information received from the purchaser terminal, matching the purchaser code with the seller code, and storing the purchaser code and the seller code; and transmitting the purchase payment information to the purchaser terminal based on the seller code and the purchaser code which are matched with each other, according to a request of the purchaser terminal acquiring the seller code stored in the NFC module of the seller terminal through NFC.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A distribution system can include a first component, a first near field communication tag, a second component, a second near field communication tag, a depository, and a first computing device. The first near field communication tag can be engaged with the first component. The first near field communication tag can have a memory storing a first identity record correlated to the first component and a first logistic record being a first of two alternative values. The second near field communication tag can be engaged with the second component. The second near field communication tag can have a memory storing a second identity record correlated to the second component and a second logistic record being the first of the two alternative values. The first component bearing the first near field communication tag and the second component bearing the second near field communication tag can be positioned in the depository. The first computing device can have one or more processors and be configured to receive a first input including the first identity record. The first computing device can also be configured to change the first logistic record stored in the memory of the first near field communication tag to a second of the two alternative values contemporaneously with receiving the first input.

A method can be performed in which data can be stored to a memory of a first near field communication tag including a first identity record correlated to a first component and a first logistic record being a first of two alternative values. Data can be stored to a memory of a second near field communication tag including a second identity record correlated to a second component and a second logistic record being the first of the two alternative values. The first near field communication tag can be engaged with the first component and the second near field communication tag can be engaged with the second component. The first component bearing the first near field communication tag and the second component bearing the second near field communication tag can be positioned in a depository. A first computing device having one or more processors can receive a first input including the first identity record. The first computing device can change the first logistic record stored in the memory of the first near field communication tag to the second of the two alternative values contemporaneously with the receiving.

### BRIEF DESCRIPTION OF THE DRAWINGS

The detailed description set forth below references the following drawings:

FIG. 1 is a schematic illustration of a system according to an exemplary embodiment of the present disclosure;

FIG. 2 is a floor plan of an exemplary depository according to an exemplary embodiment of the present disclosure;

FIG. 3 is a schematic illustration of a portion of a computing device according to an exemplary embodiment of the present disclosure;

FIG. 4 is a schematic illustration of another portion of a computing device according to an exemplary embodiment of the present disclosure;

FIG. 5 is an illustration of a user selecting a component for distribution; and

FIG. 6 is a simplified flow diagram illustrating a method that can be carried out according to one or more embodiments of the present disclosure.

### DETAILED DESCRIPTION

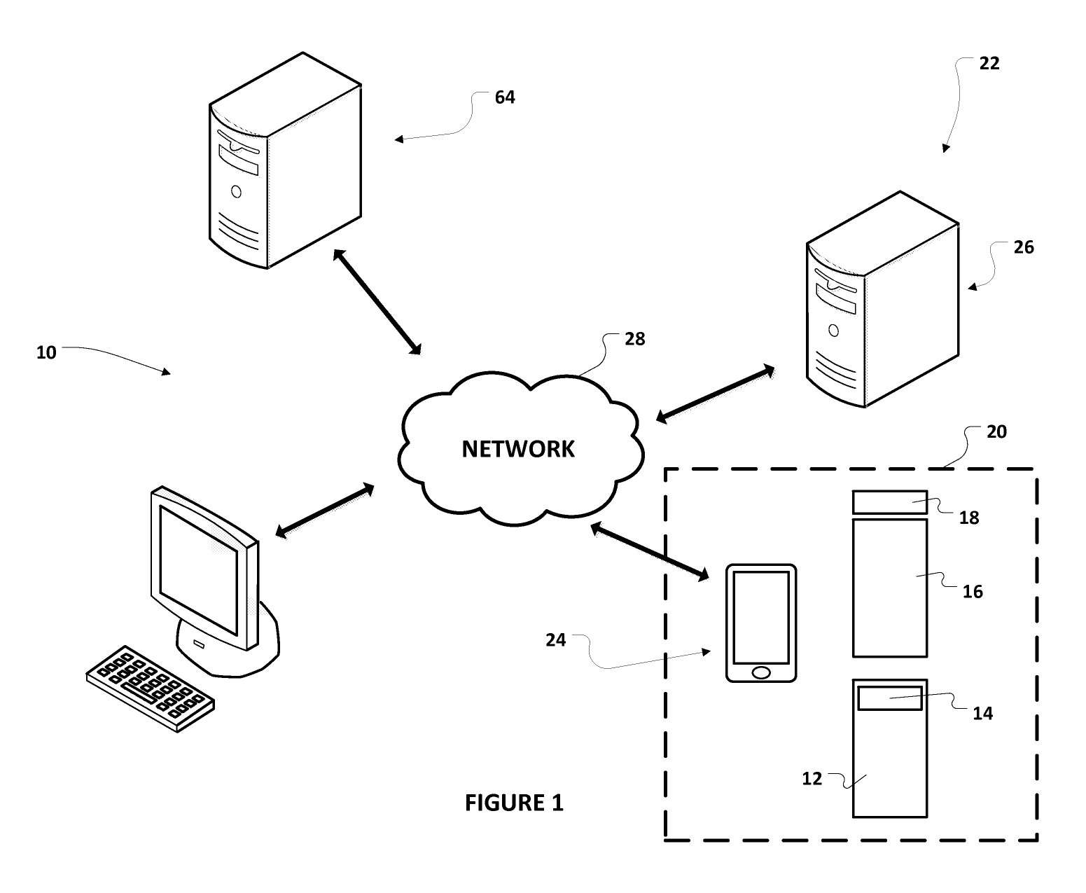

Referring now to FIG. 1, an exemplary distribution system 10 can include a first component 12, a first near field communication tag 14, a second component 16, a second near field communication tag 18, a depository 20, and a first computing device 22. The first component 12 can be an article of manufacture or a quantity of a commodity.

The first near field communication tag 14 can be engaged with the first component 12. In the exemplary embodiment, the first near field communication tag 14 can be embedded in the first component 12. The first near field communication tag 14 can have a memory storing a first identity record correlated to the first component 12 and a first logistic record being a first of two alternative values. An identity record can be data storable in the memory of a near field communication tag. The first identity record can be an alphabetic record, such as the name of the first component 12. Alternatively, the first identity record can be a numeric record, such as an SKU number of the first component 12.

A logistic record can be data storable in the memory of a near field communication tag. A logistic record can be defined by one of two alternative values. A logistic record can be defined by alphanumeric data. The first logistic record can, for example, be a “1” or a “0.” Alternatively, the first logistic record can, for example, be a “T” or a “F.”

The second near field communication tag 18 can be engaged with the second component 16. The second component 16 can be an article of manufacture or a quantity of a commodity. In the exemplary embodiment, the second near field communication tag 18 can be attached to the second component 16. The second near field communication tag 18 can have a memory storing a second identity record correlated to the second component 16 and a second logistic record being the first of the two alternative values. It is noted that in one or more embodiments of the present disclosure, the first near field communication tag 14 and the second near field communication tag 18 can be differently colored.

The first component 12 bearing the first near field communication tag 14 and the second component 16 bearing the second near field communication tag 18 can be positioned in the depository 20. By way of example and not limitation, the depository 20 can be a storage facility, such as a warehouse or a mercantile.

The first computing device 22 can function with the other components of the distribution system 10 to control the distribution of components out of the depository 20. It is noted that in various embodiments of the present disclosure, the first computing device 22 can be defined by a single physical structure such as a server, a desktop computer, a laptop computer, a tablet computer, or a mobile smart phone. Alternatively, the first computing device 22 can be defined by one or more physical structures working together.

In the exemplary embodiment, the first computing device 22 can include a mobile computing device 24. The exemplary first computing device 22 can also include a server computing device 26 working cooperatively with the mobile computing device 24. The mobile computing device 24 can be positioned in the depository 20 and be operated by person selecting components to remove from the depository. The server computing device 26 can be wireless or wired electrical communication with the mobile computing device 24. The server computing device 26 can be physically remote from the depository 20. The server computing device 26 can be configured to communicate with the mobile computing device 24 via a network 28. The network 28 can include a local area network (LAN), a wide area network (WAN), e.g., the Internet, or a combination thereof.

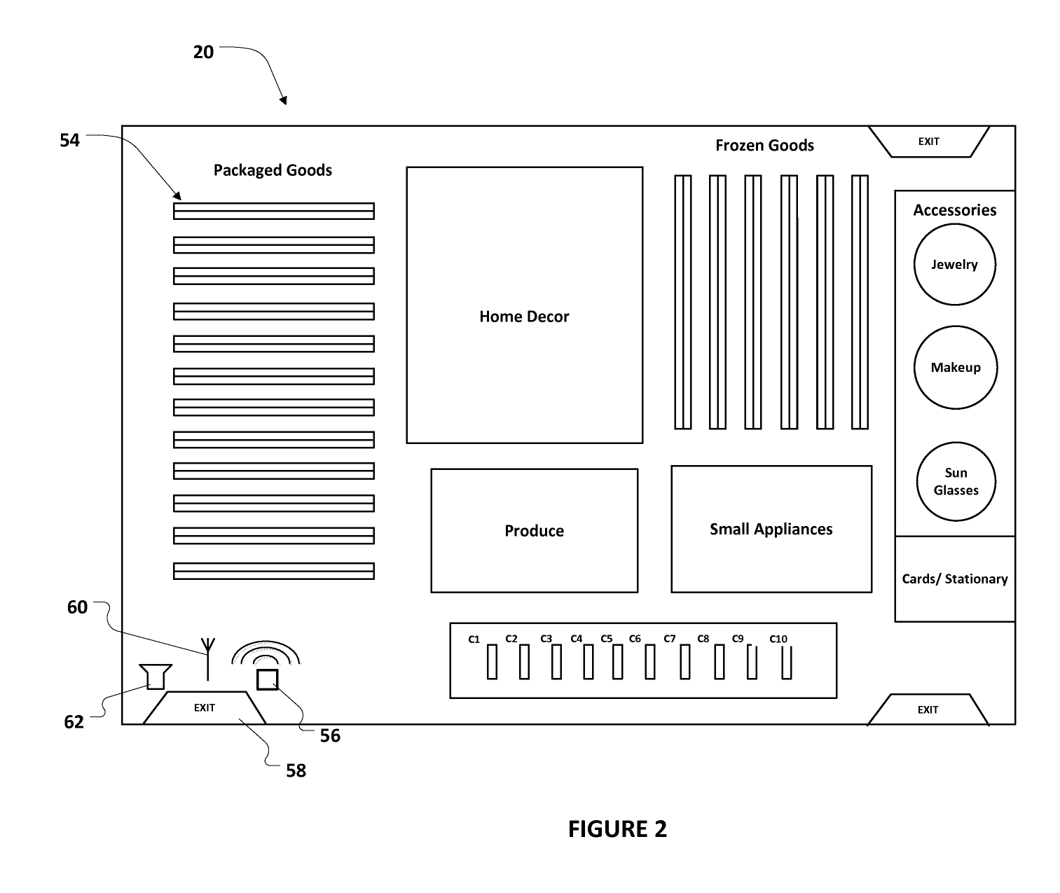

The first computing device 22 can have one or more processors and be configured to receive a first input including the first identity record. Referring now to FIG. 2, a functional block diagram of one example of the mobile computing device 24 is illustrated. The mobile computing device 24 can include a processor 30, a receiver 32, an NFC tag encoder module 34, and a transmitter 36. The processor 30 can be configured to control operation of the mobile computing device 24. It should be appreciated that the term “processor” as used herein can refer to both a single processor and two or more processors operating in a parallel or distributed architecture. The processor 30 can be configured to perform general functions including, but not limited to, loading/executing an operating system of the mobile computing device 24, controlling communication via the receiver 32 and transmitter 36, controlling read/write operations to the respective memories of the tags 14, 16 with the NFC tag encoder module 34, and controlling a display 38 of the mobile computing device 24, including creating and modifying a user interface of the distribution system 10, which is described in greater detail below.

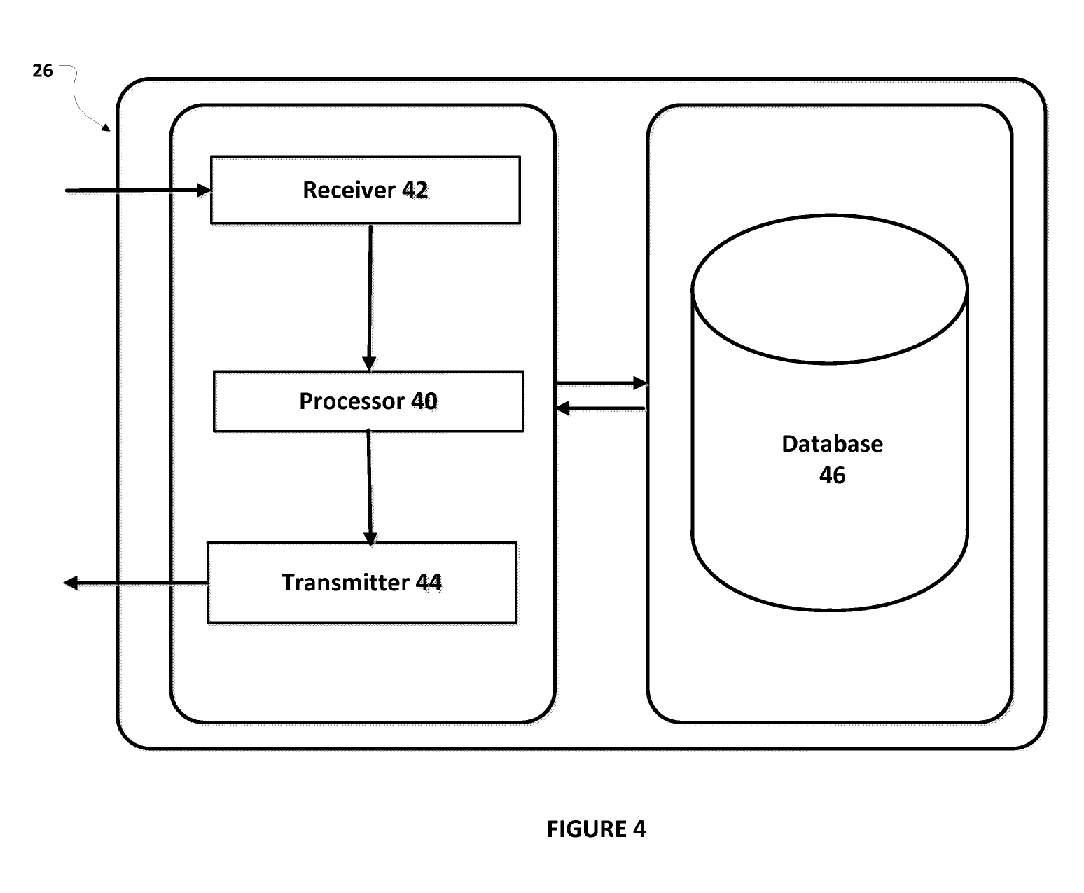

Referring now to FIG. 4, a functional block diagram of one example of the server computing device 26 is illustrated. The server computing device 26 can include a processor 40, a receiver 42, a transmitter 44, and a database 46. The processor 40 can be configured to control operation of the server computing device 26. The processor 40 can be configured to perform general functions including, but not limited to, loading/executing an operating system of the server computing device 26, controlling communication via the receiver 42 and transmitter 44, controlling read/write operations to the database 46, and controlling other devices to be described in greater detail below. The receivers 32, 42 and transmitters 36, 44 can be configured to provide for communication between the processors 30 and 40 and other devices via the network 28. The database 46 can be any suitable storage medium (flash, hard disk, etc.). The database 46 can be configured to store information at the first computing device 22, such as the identities of components positioned within the depository 20 in relation to some numbering and naming scheme. Other information about each component positioned within the depository 20 can be stored in the database 46 as well, such as a bill of material, cost, or performance properties.

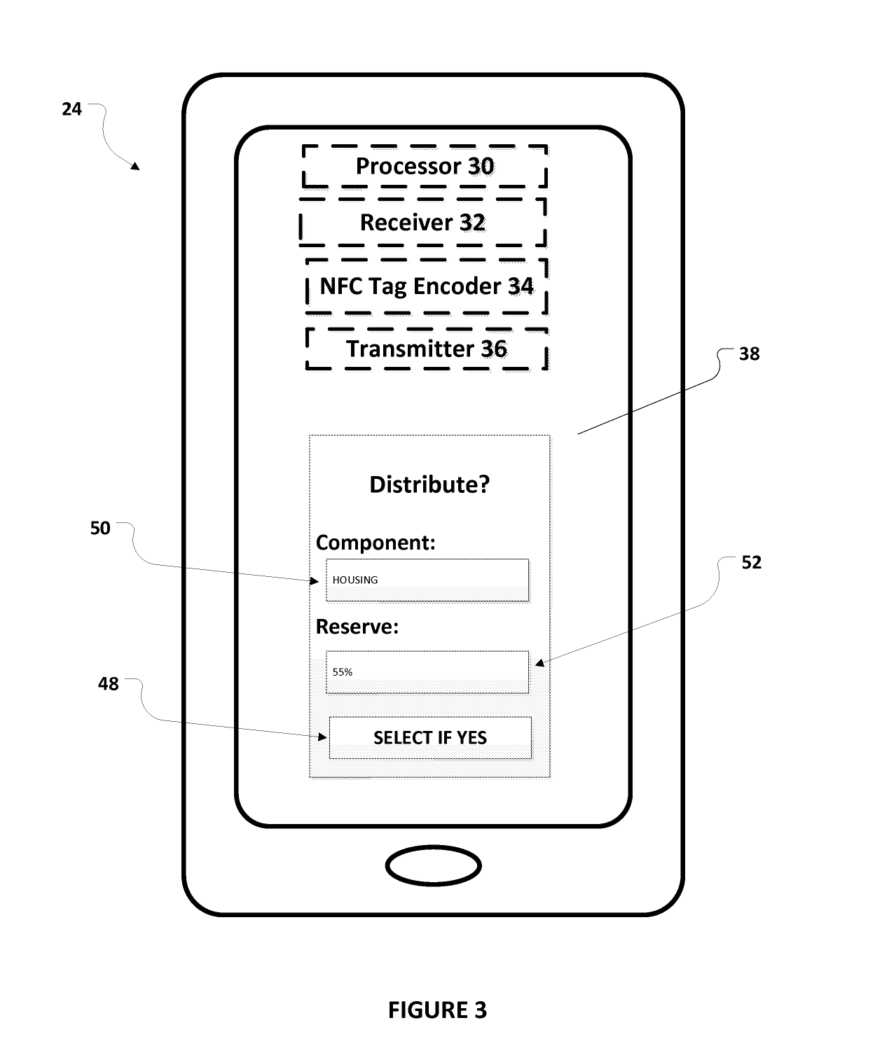

The mobile computing device 24 of the first computing device 22 can load and execute a distribution application (or app), which is illustrated by a user interface displayed in the display area of the display 38 in FIG. 3. The distribution application may not occupy the entire display area due to toolbars or other borders (not shown). The distribution application can be configured to initiate a distribution event, which includes displaying prompts to an operator of the mobile computing device 24. The distribution application can be executed by the processor 30 to control the NFC tag encoder module 34 based on data received from the server computing device 26.

The operator of the mobile computing device 24 can tap the first component 12 with the distribution application operating on the mobile computing device 24. During the tap, the first near field communication tag 14 can be powered and the data stored in the memory of the first near field communication tag 14 can be transmitted to and received by the mobile computing device 24 as a first input. The first input can include the first identity record.

In one exemplary embodiment, the mobile computing device 24 can transmit the first input to the server computing device 26. Based on the first identity record of the first input, the processor 40 of the server computing device 26 can access the database 46 to retrieve other information about the first component 12. Any other information about the first component 12 retrieved from the database 46 can be transmitted to the mobile computing device 24. The other information about the first component 12 retrieved from the database 46 and transmitted to the mobile computing device 24 can be a password or security code allowing the mobile computing device 24 to change the first logistic record. In another embodiment, the distribution app operating on the mobile computing device 24 can possess a password or security code allowing the mobile computing device 24 to change the first logistic record.

The first computing device 22 can also be configured to change the first logistic record stored in the memory of the first near field communication tag 14 to the second of the two alternative values contemporaneously with receiving the first input. The first computing device 22 can be configured to change the first logistic record to the second of the two alternative values at the same time as receiving the first input or during the tapping movement. For example, the first logistic record can be changed from a “1” to “0” or vice-versa. Alternatively, the first logistic record can be changed from an “F” to “T” or vice-versa.

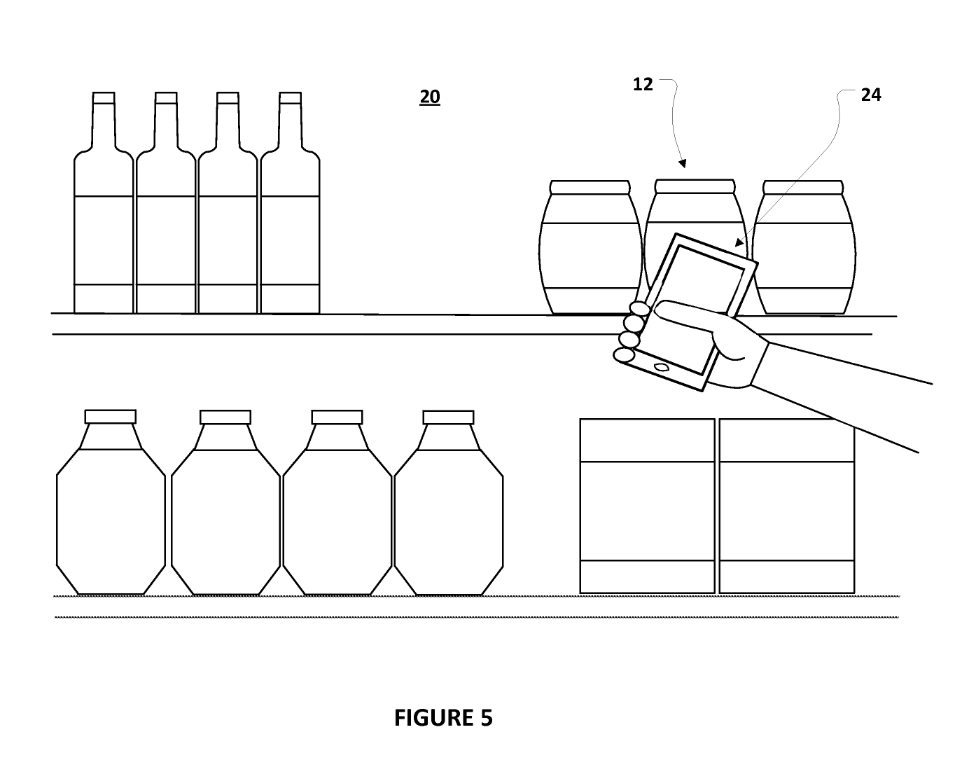

FIG. 5 illustrates a user of the mobile computing device 24 tapping a first exemplary component 12 in a depository 20. In one or more exemplary embodiments of the present disclosure, the mobile computing device 24 can be controlled by the distribution app to exhibit a button on the display 38 for selection by a user in response to the receiving the first input as show in FIG. 3. For example, after an initial tap, the distribution app can receive the first input and display a button 48 and other information about the component 12, such as the name of the component referenced at 50 and a numerical value associated such as reserve referenced at 52. The reserve value in the exemplary embodiment can be a percentage of the components 12 left in inventory. In other embodiments of the present disclosure, a numerical value such as cost, a performance property, or some other value can be displayed. If the user of the mobile computing device 24 accepts the first component 12 in view of the information displayed at 50 and 52, the button 48 can be pressed to confirm that the first component 12 will be removed from the depository 20. If the user of the mobile computing device 24 rejects the first component 12 in view of the information displayed at 50 and 52, the distribution app can direct the user to again tap the first component 12 to return the first logistic record to the first value. In other embodiments, the user can tap a first time to obtain the first identity record and be presented with the button 48. A second tap after pressing the button 48 can be utilized to change the first logistic record to the second value. A second tap after the button 48 is not pressed can be interpreted by the distribution app as an error and not result in a change to the first logistic record. In still other embodiments, a first tap can change the first logistic record to the second value and a second tap can change the first logistic record back to the first value, thus cancelling the permission to remove the first component from the depository 20.

An exemplary depository 20 is illustrated in FIG. 2. The depository 20 can define an enclosed area to store components. The floor space of the depository 20 can be subdivided to arrange components together in categories such as shown in FIG. 2. The components can be positioned on shelving units in the depository, such as shelving unit 54. The distribution system 10 can include an electromagnetic field emitter 56 positioned at an exit 58 of the depository 20. The electromagnetic field emitter 56 can be configured to power the first near field communication tag 14 and the second near field communication tag 18 when the tags 14, 16 enter the magnetic field generated by the emitter 56. The distribution system 10 can also include an antenna 60 configured to receive one or more inputs from the first near field communication tag 14 and the second near field communication tag 18 at the exit 58. The server computing device 26 can be arranged to receive inputs through the antenna 60. The distribution system 10 can also include an alarm 62 positioned at the exit 58 of the depository 20. The alarm 62 can be controlled at least on part by the server computing device 26. The alarm 62 can emit an audible noise or a visual display when activated. It is noted that emitters, antennas, and alarms can be positioned at all of the exits of the depository.

In operation, an electromagnetic field can emit an electromagnetic field at the exit 58 of the depository 20. A tag passing through the exit 58 can be powered and emit a signal containing the logistic record. The signal can be received by the antenna 60 and communicated to the server computing device 26. If, for example, the logistic record is “1” or “F,” the server computing device 26 can activate the alarm 62. Alternatively, if the logistic record is “0” or “T,” the server computing device 26 can maintain the alarm 62 in a deactivated condition. Thus, the component 12 cannot be removed from the depository without the logistic record being changed. If the logistic record has been changed, the component can be removed from the depository 20 without the user of the mobile computing device 24 having to interact with another person.

Referring again to FIG. 1, the distribution system 10 can communicate with a second computing device 64 in response to the receiving the first input. After the logistic record has been changed, indicating that the first component 12 will be removed from the depository 20, the server computing device 26 or the mobile computing device 24 can transmit an output to the second computing device 64 for processing by the second computing device 64. For example, the second computing device 64 can be a computing device of a supplier and transmission of the output can advise the supplier to ship additional components. In another example, the second computing device 64 can be accounting device to transfer payment for the first component. In one or more embodiments, the output to the second computing device 64 can be transmitted after the first component 12 has left the depository 20.

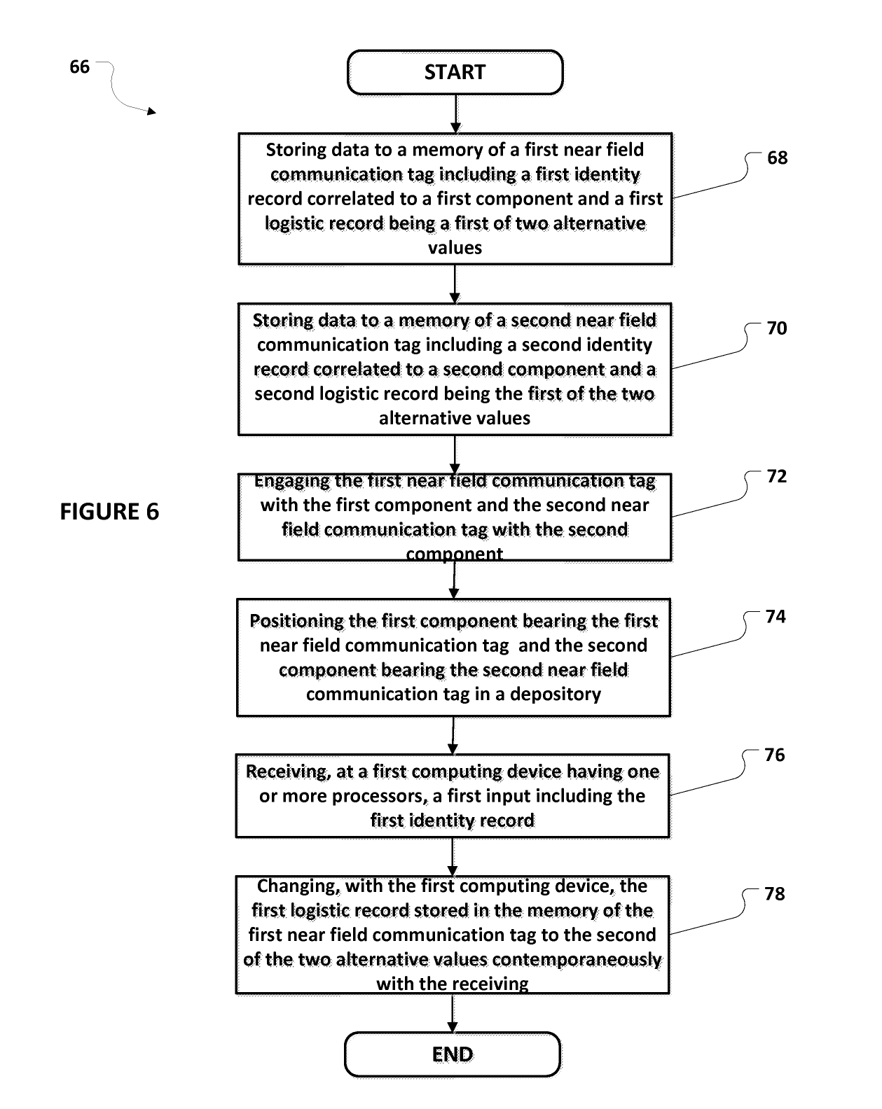

Referring now to FIG. 6, a flow diagram of an example method 66 for assisting a user in distributing a component with the distribution application as illustrated. At step 68, data can be stored to a memory of a first near field communication tag 14 including a first identity record correlated to a first component 12 and a first logistic record being a first of two alternative values. At step 70, data can be stored to a memory of a second near field communication tag 18 including a second identity record correlated to a second component 16 and a second logistic record being the first of the two alternative values. At step 72, the first near field communication tag 14 can be engaged with the first component 12 and the second near field communication tag 18 can be engaged with the second component 16. At step 74, the first component 12 bearing the first near field communication tag 14 and the second component 16 bearing the second near field communication tag 18 can be positioned in a depository 20. At step 76, a first computing device 22 having one or more processors can receive a first input including the first identity record. At step 78, the first computing device 22 can change the first logistic record stored in the memory of the first near field communication tag 14 to the second of the two alternative values contemporaneously with the receiving.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. Further, the “present disclosure” as that term is used in this document is what is claimed in the claims of this document. The right to claim elements and/or sub-combinations that are disclosed herein as other present disclosures in other patent documents is hereby unconditionally reserved.

What is claimed is:

1. A computer-implemented method comprising:
storing data to a memory of a first near field communication tag including a first identity record correlated to a first component and a first logistic record being a first of two alternative values;
storing data to a memory of a second near field communication tag including a second identity record correlated to a second component and a second logistic record being the first of the two alternative values;
engaging the first near field communication tag to the first component and the second near field communication tag to the second component;
positioning the first component bearing the first near field communication tag and the second component bearing the second near field communication tag in a depository;
receiving, at a first computing device having one or more processors, a first input including the first identity record; and
changing, with the first computing device, the first logistic record stored in the memory of the first near field communication tag to the second of the two alternative values contemporaneously with said receiving.

2. The computer-implemented method of claim 1 further comprising:
emitting an electromagnetic field at an exit of the depository;
positioning an antenna at the exit; and
receiving, at the first computing device, a second input from the first near field communication tag with the antenna including the first logistic record after said changing.

3. The computer-implemented method of claim 2 further comprising:
receiving, at the first computing device, a third input with the antenna including the second logistic record;
positioning an alarm at the depository; and
activating, with the first computing device, the alarm in response to said receiving the third input.

4. The computer-implemented method of claim 3 further comprising:
maintaining the alarm in a deactivated condition in response to said changing and said receiving the second input.

5. The computer-implemented method of claim 1 wherein said changing further comprises:
controlling, with the first computing device, a display to exhibit a button for selection by a user in response to said receiving the first input; and
receiving, at the first computing device, a fourth input indicative of selection of the button by the user.

6. The computer-implemented method of claim 5 wherein said changing further defined as:
changing, with the first computing device, the first logistic record stored in the memory of the first near field communication tag to the second of the two alternative values only in response to said receiving the selection input.

7. The computer-implemented method of claim 5 wherein said changing further comprises:
controlling, with the first computing device, the display to distribution information associated with the first component in response to said receiving the first input.

8. The computer-implemented method of claim 1 further comprising:
transmitting, with the first computing device, a first output to a second computing device in response to said receiving the first input.

9. The computer-implemented method of claim 8 wherein said transmitting device is further defined as:
transmitting, with the first computing device, the first output after said changing.

10. The computer-implemented method of claim 8 further comprising:
emitting an electromagnetic field at an exit of the depository;
positioning an antenna at the exit;
receiving, at the first computing device, a second input from the first near field communication tag with the antenna including the first logistic record after said changing; and
wherein said transmitting device is further defined as transmitting, with the first computing device, the first output after said receiving the second input.

11. The computer-implemented method of claim 1 further comprising:
receiving, at the first computing device, a fifth input including the first identity record; and
changing, with the first computing device, the first logistic record stored in the memory of the first near field communication tag to the first of the two alternative values in response to said receiving the fifth input.

12. A distribution system comprising:
a first component;
a first near field communication tag engaged with said first component, said first near field communication tag having a memory storing a first identity record correlated to the first component and a first logistic record being a first of two alternative values;
a second component;
a second near field communication tag engaged with said second component, said second near field communication tag having a memory storing a second identity record correlated to said second component and a second logistic record being said first of said two alternative values;
a depository in which said first component bearing said first near field communication tag and said second component bearing said second near field communication tag are positioned; and
a first computing device having one or more processors and configured to receive a first input including said first identity record and to change said first logistic record stored in said memory of said first near field communication tag to a second of said two alternative values contemporaneously with receiving said first input.

13. The distribution system of claim 12 wherein said first computing device further comprises:
a mobile computing device positioned in said depository.

14. The distribution system of claim 13 wherein said first computing device further comprises:
a server computing device in electrical communication with said mobile computing device.

15. The distribution system of claim 14 wherein said server computing device is remote from said depository.

16. The distribution system of claim 15 wherein said mobile computing device receives said first input and communicates said first input to said server computing device.

17. The distribution system of claim 16 wherein said server computing device controls said mobile computing device to change said first logistic record stored in said memory of said first near field communication tag to said second of said two alternative values.

18. The distribution system of claim 17 further comprising:
an electromagnetic field emitter positioned at an exit of said depository configured to power said first near field communication tag and said second near field communication tag;
an antenna configured to receive one or more inputs from said first near field communication tag and said second near field communication tag at said exit, said server computing device arranged to receive inputs through said antenna; and
an alarm positioned at said depository and controlled at least on part by said server computing device.

19. The distribution system of claim 12 wherein said first near field communication tag and said second near field communication tag are differently colored.

20. The distribution system of claim 12 wherein said first near field communication tag is embedded in said first component.
